(19) United States
(12) Patent Application Publication
(10) Pub. No.: US 2014/0229526 A1
(43) Pub. Date: Aug. 14, 2014

(54) SYSTEMS, METHODS AND MEDIA FOR SECURELY EXECUTING REMOTE COMMANDS USING CROSS-PLATFORM LIBRARY

(71) Applicant: APPSENSE LIMITED, Warrington (GB)

(72) Inventor: Joseph SAIB, Santa Clara, CA (US)

(73) Assignee: APPSENSE LIMITED, Warrington (GB)

(21) Appl. No.: 13/766,625

(22) Filed: Feb. 13, 2013

(51) Int. Cl. H04L 29/06

(52) U.S. Cl. CPC H04L 67/42
USPC 709/203

(57) ABSTRACT

Systems, methods and media are provided for secure execution of remote commands. One method includes receiving, at a client device running a cross-platform library comprising a list of functions that can be executed at the client device, a remote command from a server. The remote command includes components including a triggering event and an action to be taken when the triggering event is detected. The method also includes evaluating the remote command by parsing the remote command to extract the set of components and interpreting the parsed set of components to determine whether the action can be implemented using at least one function in the list of functions. The method further includes selecting the function for implementing the action by setting up the selected function to be executed when the triggering event is detected, if it is determined that the action can be implemented using the function.

### TECHNICAL FIELD

Disclosed systems, methods and media relate to secure execution of remote commands. Specifically, disclosed systems, methods and media relate to securely executing remote commands received from a server over a network (e.g., an unsecured network) using a cross-platform library including a set of high-level functions with little or no capacity for performing low level system operations.

### BACKGROUND

Arbitrary code execution, in computer security, refers to an attacker's ability to execute any command of the attacker's choice on a target machine or a target process. The ability to trigger an arbitrary code execution from one machine on another is referred to as (arbitrary) remote code execution. An attacker explores a bug or other exposed vulnerability of a program to first take over a process running an instance of the vulnerable program. From there, the attacker can take complete control over the machine running the process.

Arbitrary code execution is commonly achieved through taking control over the program counter (also referred to as instruction pointer) of a running process. The program counter points to the next instruction in the process that is to be executed. Control over the value of the program counter therefore gives control over which instruction is executed next. In order to execute an arbitrary code, for example, an attacker can inject the code into a vulnerable process, e.g., by sending an input to the input buffer of the process, and exploit a vulnerability (e.g., a software defect) to modify the program counter to have it point to the injected code. The injected arbitrary code will be then automatically executed. A program designed by such an attacker exploits the fact that many computers do not make a general distinction between data and executable code by camouflaging a malicious code as harmless data.

Once the attacker can execute the arbitrary code directly on the low-level functions of an operating system, the code often attempts to elevate a privilege level of the process running the code to gain additional control. Achieving this privilege elevation helps the attacker hide the attack from the legitimate administrators of the machine/system. Arbitrary remote code execution, therefore, has the potential to do severe damage or turn the machine/system into a zombie that performs malicious tasks under an attacker's remote directions. Worse still, it can continue spreading the attack from one machine to the next, thereby turning many more machines/systems into the same zombie state.

### SUMMARY

In accordance with the disclosed subject matter, systems, methods and media are provided for secure execution of remote commands. Specifically, disclosed systems, methods and media provide for securely executing remote commands that are received from a server over a network using a cross-platform library. For example, the disclosed subject matter includes a method that includes receiving, at a client device running an instance of a cross-platform library comprising a list of functions that can be executed at the client device, a remote command for implementing a policy from a server over a network. The remote command includes a set of components including a triggering event and an action to be taken when the triggering event is detected. The method also includes evaluating at the client device the remote command using the cross-platform library by parsing the remote command to extract the set of components and interpreting the parsed set of components to determine whether the action can be implemented using at least one function in the cross-platform library. The method further includes selecting, at the client device, the function in the cross-platform library for implementing the action by setting up the function to be executed when the triggering event is detected, if it is determined that the action can be implemented using the function in the cross-platform library.

In some embodiments, the method may further include authenticating the server before evaluating the remote command. In some embodiments, the method includes deleting the remote command without further evaluating or implementing the remote command, if it is determined that the action cannot be implemented using the function in the cross-platform library. In some embodiments, no function or combination of functions in the list of functions is capable of elevating a privilege level of a process running the cross-platform library instance in the client device or capable of deleting any data stored in the client device without first backing up the data. In some embodiments, setting up the function in the cross-platform library includes providing one or more input parameters that are required by the function for execution. In some embodiments, the set of components further includes at least one alphanumeric byte string representing a numerical value and providing the one or more input parameters includes using the at least one alphanumeric byte string for the one or more parameters.

In some embodiments, setting up the function includes determining whether the triggering event has already taken place. If it is determined that the triggering event has already taken place, the method further includes executing the function. If it is determined that the triggering event has not taken place yet, however, the method further includes setting up an event handler that monitors for the triggering event and executes the function upon detecting the triggering event. In some embodiments, setting up the event handler includes passing the function by reference to the event handler as a callback function. In some embodiments, the remote command consists of a plurality of alphanumeric byte characters. In some embodiments, the cross-platform library is implemented as a dynamic link library. In some embodiments, the cross-platform library is provided from the server.

The disclosed subject matter also includes an apparatus that includes one or more interfaces configured to provide communication with one or more devices over a network and a processor in communication with the one or more interfaces. The processor is configured to run an instance of a cross-platform library stored in memory that is configured to receive a remote command for implementing a policy from a server over the network. The remote command includes a set of components including a triggering event and an action to be taken when the triggering event is detected. The cross-platform library includes a list of functions that can be executed at the apparatus. The cross-platform library is also configured to evaluate the remote command by parsing the remote command to extract the set of components and interpreting the parsed set of components to determine whether the action can be implemented using at least one function in the cross-platform library. The cross-platform library is further configured to select the function for implementing the action by setting up the function to be executed when the triggering event is detected, if it is determined that the action can be implemented using the function.

The disclosed subject matter further includes a non-transitory computer readable medium having executable instructions operable to cause an apparatus running an instance of a cross-platform library to receive a remote command for implementing a policy from a server over a network. The remote command includes a set of components including a triggering event and an action to be taken when the triggering event is detected. The cross-platform library includes a list of functions that can be executed at the apparatus. The instructions are also operable to cause the apparatus to evaluate the remote command using the cross-platform library by parsing the remote command to extract the components and interpreting the parsed set of components to determine whether the action can be implemented using at least one function in the cross-platform library. The instructions are further operable to cause the apparatus to select the function in the cross-platform library for implementing the action by setting up the function to be executed when the triggering event is detected, if it is determined that the action can be implemented using the function.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

In this respect, before explaining at least one embodiment of the disclosed subject matter in detail, it is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be had to the accompanying drawings and descriptive matter in which there are illustrated preferred embodiments of the disclosed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates a diagram of a networked communication system in accordance with an embodiment of the disclosed subject matter.

FIG. 2 is a flow diagram for securely executing a remote command using a cross-platform library in accordance with an embodiment of the disclosed subject matter.

FIG. 3 is a block diagram of a computing device in accordance with an embodiment of the disclosed subject matter.

### DETAILED DESCRIPTION

In the following description, numerous specific details are set forth regarding the systems, methods and media of the disclosed subject matter and the environment in which such systems, methods and media may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the subject matter of the disclosed subject matter. In addition, it will be understood that the examples provided below are exemplary, and that it is contemplated that there are other systems and methods that are within the scope of the disclosed subject matter.

The disclosed systems, methods and media are provided for secure execution of remote commands using a cross-platform library. In one embodiment, for example, a system administrator managing a system including a network of application servers can create a user policy regarding the network security of the system. For instance, the system administrator can implement a policy requiring a login password stored in a user's device to be reset if the user fails to login to the system using her device for 10 days.

The network of application servers provides application services to a plurality of registered client devices. Each registered client device runs an instance of a policy library that is downloaded from a server in the system. The policy library includes a set of functions that can run in each client device. The policy library, for instance, can be a cross-platform library that is distributed by the system administrator and can include a set of functions that can run on a particular platform (e.g., Google's Android™, Apple's iOS™, etc.). The system operator that owns and/or manages the application servers, in some embodiments, develops a cross-platform library for each specific platform to accommodate registered client devices that are built on different platforms. The policy library can be implemented as a dynamic link library. A dynamic link library is a type of shared library having a set of functions that are linked and invoked by the calling programs during a run-time (as opposed to during a compile/link time).

In order to implement the security policy, the system administrator generates a remote command that can be sent to each of the registered client devices. For example, the system administrator can generate a remote command at a server by specifying a set of components, such as a triggering event (e.g., a user's failure to login to the system in 10 days) and a triggered action (e.g., reset the user's login password stored in the user's device). For instance, the remote command can be included in a simple text message. When a command is generated, the system administrator transmits the command to the registered client devices from the server.

Upon receiving the (remote) command from the server over a network, a client device running an instance of the policy library evaluates the command by parsing the command to extract the set of components using the policy library. Once the command is parsed and its components are identified, the policy library constructs the intended policy to be implemented using a predefined set of rules (e.g., syntactic, semantic rules). The policy library next determines based on the constructed policy whether the triggered action(s) specified in the command can be performed using one or more functions included in the policy library. For example, the policy library determines that resetting the login password can be performed by a policy library function and selects the function.

The policy library next determines the last time when the user of the client device logged in to the system to request and receive application services. When the policy library determines that the user has not logged in to the system for the past 7 days, the policy library sets up an event handler that can detect the triggering event. For example, the policy library can pass to the event handler a reference to the selected library function (e.g., a function pointer) as an input parameter (i.e., a callback function) and configure the event handler for detecting when the user of the client device fails to login to the system for 10 days. For instance, the event handler can include a timer that expires when the user of the client device fails to login for 10 days. The timer can be reset, however, if the user logs in to the system at least once in a 10-day period.

If the timer expires, the event handler invokes the callback function to reset the user's login password. When the user attempts to login to the system after the password is reset by the callback function (i.e., the selected policy library function), a message can be displayed for the user to contact the system administrator to receive a temporary password for logging in to the system again.

The example policy described herein is merely exemplary and the invention applies to any other suitable policy or combination of policies, such as a policy requiring data stored in one or more file folders in a user device to be deleted if a user fails to provide a correct combination of a login name and a password for logging into a system over a network for 3 consecutive attempts using the user device and a policy requiring a user to provide a correct system/network login credential again if a period of inactivity is detected after an initial login, to name but a few.

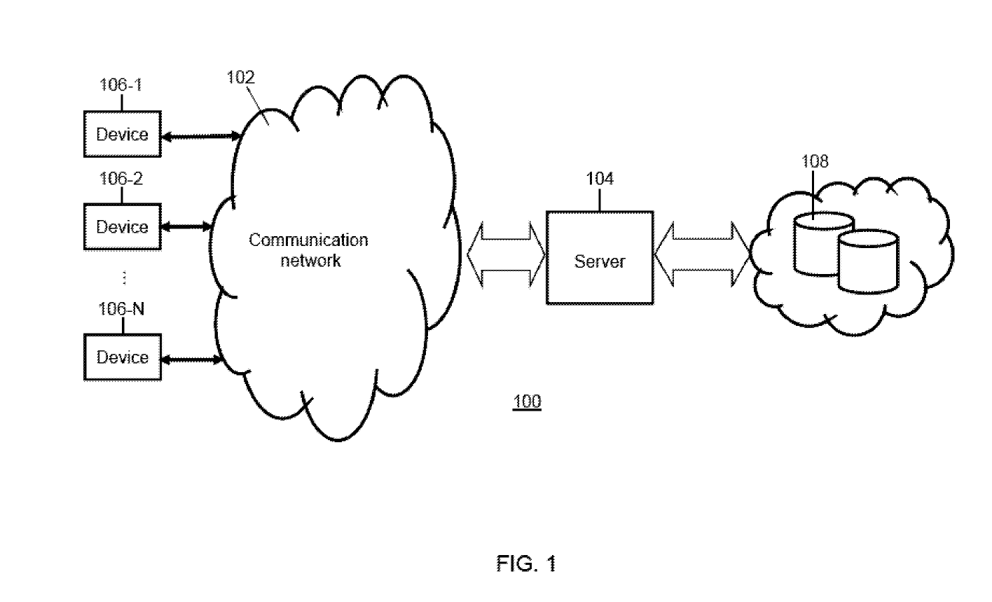

FIG. 1 illustrates a diagram of a networked communication arrangement 100 in accordance with an embodiment of the disclosed subject matter. The networked communication arrangement 100 can include a communication network 102, a server 104, at least one computing device 106 (e.g., computing devices 106-1, 106-2, . . . 106-N), and a database 108.

Each computing device 106 can send data to, and receive data from, the server 104 over the communication network 102. Each computing device 106 can be directly coupled to the server 104; alternatively, each computing device 106 can be connected to server 104 via any other suitable device(s), communication network(s), or combination thereof. For example, each computing device 106 can be coupled to the server 104 via one or more routers, switches, access points, and/or communication networks (as described below in connection with communication network 102). A computing device 106 can include a desktop computer, a mobile computer, a tablet computer, a cellular device, a smartphone or any computing system that is capable of performing computation.

The server 104 can be a single server, or a network of servers, or a farm of servers in a data center. For example, the server 104 may be a server located in a network operating center for generating and sending commands to client computing devices for implementing (administrative) policies. For instance, the server 104 may run an instance of an administrative tool for generating commands for implementing policies related to the network security or the usage of the network resources.

The communication network 102 can include a network or combination of networks that can accommodate private data communication. For example, the communication network 102 can include a local area network (LAN), a virtual private network (VPN) coupled to the LAN, a private cellular network, a private telephone network, a private computer network, a private packet switching network, a private line switching network, a private wide area network (WAN), a corporate network, or any number of private networks that can be referred to as an Intranet. Such networks may be implemented with any number of hardware and software components, transmission media and network protocols. FIG. 1 shows the network 102 as a single network; however, the network 102 can include multiple interconnected networks listed above.

The server 104 can be coupled to a database system. The database 108 can include at least one of two types of database: a local database and a remotely located database. The database 108 can include any data supported by one or more data structures; alternatively, it could include one or more database management system (DBMS) or a distributed database. The database 108 can also include at least one of a relational database, object database (a.k.a., object-oriented database), XML database, cloud database, active database, and a data warehouse. The database 108 may include at least one physical, non-transitory storage medium.

In some embodiments, the database 108 can be provided as an enterprise system in a corporate environment For example, the communication network 102, the (proxy) server 104, the computing devices 106, and the database 108 can be located in close proximity and can be a part of a single company. In some cases, the (proxy) server 104, the computing devices 106, and the database 108 can be located in the same building and can be coupled to one another via a local communication network. The local communication network can include a local area network (LAN), a corporate network, and a virtual private network (VPN) associated with the corporate network. FIG. 1 shows the database 108 as separate from the communication network 102. However, the database 108 can be part of communication network 102 or another communication network.

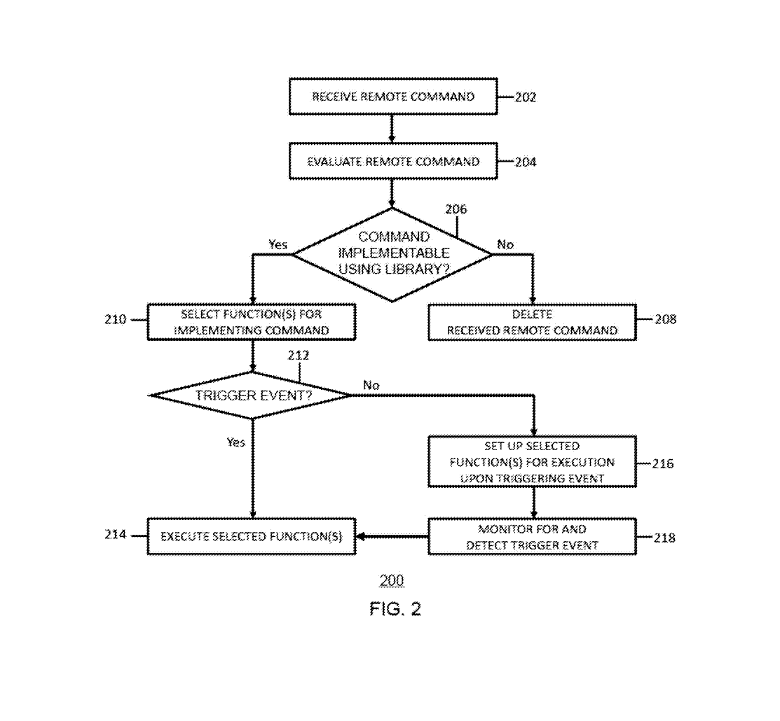

FIG. 2 is a flow diagram 200 for securely executing a remote command using a cross-platform library in accordance with an embodiment of the disclosed subject matter. At 202, a remote command is received at a computing device (e.g., client device), such as computing device 106, from a server (e.g., server 104) over a network (e.g., communication network 102). The remote command may include a set of components, such as a triggering event and an action to be triggered when (or some time after) the triggering event takes place. The computing device 106 may run an instance of a library (e.g., cross-platform library, a policy library, etc.) that includes a set of functions that can be executed at the client device 106.

In some embodiments, the remote command is sent to the computing device 106 to implement a policy, e.g., related to the usage of the client device or the manner in which the computing device 106 interacts with the server 104 or other devices over the communication network 102. In some embodiments, the functions included in the library are high-level functions that are not capable of performing the system-level operations that can change the system status. For example, the library functions are not capable of performing operating system, or kernel-level, operations that can modify or delete system files or elevate a privilege level of a process. In some embodiments, the sender device (e.g., server) and/or the author of the remote command are/is authenticated before the remote command is evaluated.

At 204, the remote command is evaluated at the computing device 106 using the library. For example, the computing device 106 may parse the received remote command to extract the individual components, such as a triggering event (e.g., 10 consecutive failed attempts to login to a mobile device) and at least one action (e.g., delete all the local files after backing it up at a server) to be triggered when the triggering event takes place. The computing device 106 may then interpret the remote command using the parsed components to determine at 206 whether the one or more triggered actions specified in the remote command may be performed using only a function or a subset of functions included in the set of library functions.

If it is determined at 206 that the triggered action(s) specified in the remote command cannot be completed using only the library-defined functions, the computing device 106 deletes the received remote command at 208. Suppose, for example, the remote command received at a mobile phone requires that the login of the mobile device be disabled by deleting a system directory. If there is no function (or no combination of functions) defined in the library that can allow such deletion, then the remote command may be categorized as a potential attack and deleted.

If, however, it is determined at 206 that the triggered action(s) specified in the remote command can be completed using only the library defined functions, the computing device 106 selects at 210 one or more functions from the set of functions defined (or listed) in the library that can be used to implement the specified action(s). It may be possible that there are more than one subset of functions within the set of library-defined functions that can implement the specified action(s). In that event, the client device 106 can choose one of the subsets of functions to be used to implement the triggered action(s). For example, the client device 106 may choose a subset of functions requiring the least amount of system (e.g., memory or processing) resources or a subset of functions requiring the least interference with other ongoing tasks/processes.

Once function(s) are selected for implementing the triggered action(s) specified in the remote command at 210, next the computing device 106 determines at 212 whether the triggering event specified in the remote command has already taken place. If it is determined at 212 that the triggering event specified in the remote command has already taken place, the computing device 106 executes the selected function(s) at 214. Suppose, for example, a remote command requiring that a password used to login to a mobile phone that is older than 90 days be changed, is received at a mobile phone. If the current login password for the mobile phone is 95 days old at the time the remote command is received, the user of the mobile phone is prompted to change her login password the next time when the mobile phone user tries to login.

If, however, it is determined at 212 that the triggering event has not taken place yet, the computing device 106 sets up the selected functions at 216 for execution upon detecting an occurrence of the triggering event and monitors for the triggering event at 218. In some embodiments, setting up the selected functions includes providing one or more input parameters required by the selected functions. The computing device 106 executes the selected function(s) at 214 when the triggering event is detected. In some embodiments, the computing device 106 sets up an event handler to monitor for an occurrence of the triggering event and to execute the selected functions upon detecting the triggering event. In some embodiments, the selected functions are passed by reference as input parameters (callback functions) to the event handler.

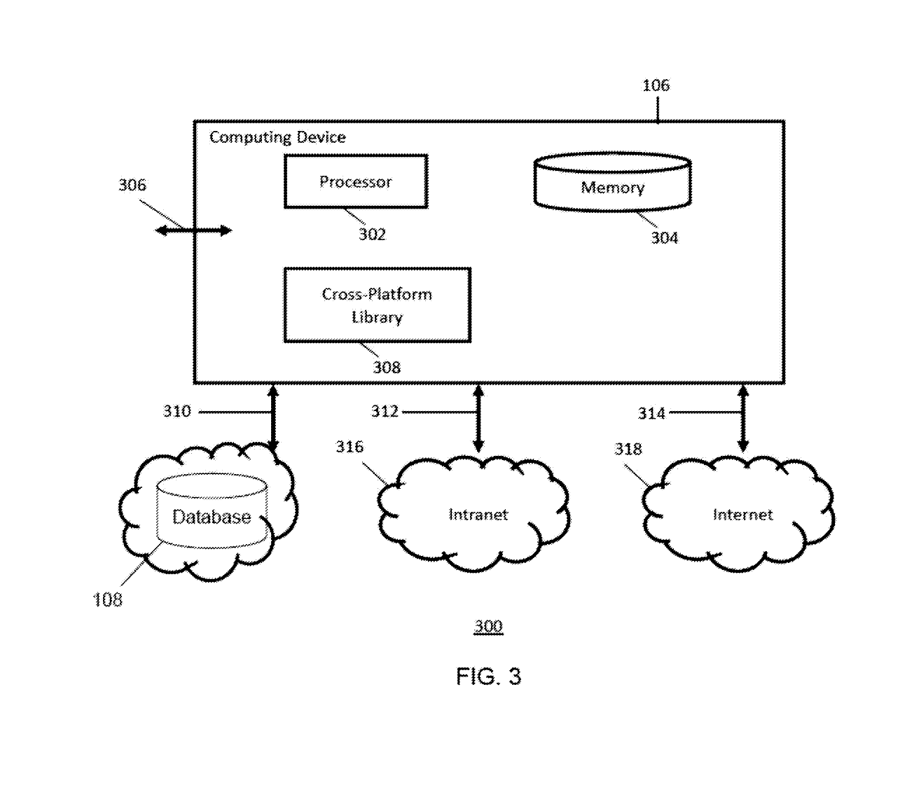

FIG. 3 is a block diagram 300 of the computing device 106 in accordance with certain embodiments of the disclosed subject matter. The block diagram 300 shows a computing device 106, which includes a processor 302, a memory 304, interfaces 306, 310, 312, and 314, a cross-platform library 308, a database 108, an Intranet 316, and the Internet 318. The memory 304 and the interfaces 306, 310, 312, and 314 are communicatively coupled to the processor 302. The computing device 106 can communicate with the server 104 (not shown) via the interface 306; the computing device 106 can communicate with the database 108 via the interface 310; the computing device 106 can communicate with the Intranet 316 via the interface 312; and the computing device 106 can communicate with the Internet 318 via the interface 314. The interfaces 306, 310, 312, and 314 are shown as separate interfaces but may be the same physical interface. The processor 302 can run software programs and modules, including the cross-platform library 308. The memory 304 is capable of storing data that can be used by the processor 302 to run the software programs and modules, including the cross-platform library 308.

The cross-platform library 308 can be configured to communicate, or interact, with server 104 through the interface 306 for secure execution of remote commands received at the cross-platform library 308 from server 104. For example, the cross-platform library 308 can receive a remote command for implementing a policy from a server (e.g., the server 104) over the communication network 102, wherein the remote command includes a set of components including a triggering event and an action to be triggered when the triggering event takes place. In some embodiments, the cross-platform library 308 includes a list of functions that can be executed at the computing device 106.

The cross-platform library 308 can also evaluate the remote command by parsing the remote command to extract the components and interpreting the remote command using the parsed components to determine whether the triggered action can be implemented using a function or a combination of functions in the list of library functions only.

If it is determined that the action can be implemented using the list of functions only, the cross-platform library 308 can further select one or more functions in the list of functions for implementing the action and set up the one or more functions to be executed when the triggering event is detected. In some embodiments, the cross-platform library 308 can also authenticate the server (or an author of the remote command) before evaluating the remote command. In some embodiments, the cross-platform library 308 can set up the selected functions by further determining, upon completion of evaluating the remote command, whether the triggering event has already taken place and, if the triggering event has taken place, executing the selected functions. If, however, the triggering event has not occurred yet, the cross-platform library 308 can set up an event handler that can monitor for the triggering event and execute selected functions upon detecting the triggering event.

FIG. 3 shows a computing device 106 having the cross-platform library 308 that performs the above-described operations in accordance with certain embodiments of the disclosed subject matter. The computing device 106 may include additional modules, less modules, or any other suitable combination of modules that perform any suitable operation or combination of operations.

The interfaces 306, 310, 312, and 314 provide an input and/or output mechanism to communicate over a network. The interfaces 306, 310, 312, and 314 enable communication with the computing devices 106, as well as other network nodes in the communication network 102. The interfaces 306, 310, 312, and 314 can be implemented in hardware to send and receive signals in a variety of mediums, such as optical, copper, and wireless, and in a number of different protocols some of which may be non-transient.

The computing device 106 can include user equipment (also referred to as mobile device, mobile terminal, etc.). The user equipment communicates with one or more radio access networks and with wired communication networks. The user equipment can be a cellular phone having phonetic communication capabilities. The user equipment can also be a smart phone providing services such as word processing, web browsing, gaming, e-book capabilities, an operating system, and a full keyboard. The user equipment can also be a tablet computer providing network access and most of the services provided by a smart phone. The user equipment operates using an operating system such as Symbian OS, iPhone OS, RIM's Blackberry, Windows Mobile, Linux, HP WebOS, and Android. The screen might be a touch screen that is used to input data to the mobile device, in which case the screen can be used instead of the full keyboard. The user equipment can also keep global positioning coordinates, profile information, or other location information.

The computing device 106 also includes any platforms capable of computations and communication. Non-limiting examples can include televisions (TVs), video projectors, set-top boxes or set-top units, digital video recorders (DVR), computers, netbooks, laptops, and any other audio/visual equipment with computation capabilities. The computing device 106 is configured with one or more processors that process instructions and run software that may be stored in memory. The processor also communicates with the memory and interfaces to communicate with other devices. The processor can be any applicable processor such as a system-on-a-chip that combines a CPU, an application processor, and flash memory. The computing device 106 can also provide a variety of user interfaces such as a keyboard, a touch screen, a trackball, a touch pad, and/or a mouse. The computing device 106 may also include speakers and a display device in some embodiments.

The disclosed systems, methods and media are provided for secure execution of remote commands using a cross-platform library. In some embodiments, for example, a system/network operator's administrator managing a network system at a server can set a policy regarding network security. The network system previously had a policy requiring every user to change her password every 90 days. However, a recent surge of security breaches experienced by other network operators has made the administrator realize that the 90-day period is simply too long for maintaining a tight system/network security. The administrator therefore decides to shorten the 90-day period to 30 days and prepares a remote command that can be sent to all of the registered client devices.

In some embodiments, a graphical user interface for generating a command for implementing a policy is provided to the administrator at the server. For example, an administrative tool running a window screen including several text dropboxes and input textboxes can be provided so that the administrator can, e.g., select from a “trigger event” dropbox listing different types of available trigger event (e.g., password expiration, failed login attempt, etc.) and/or can provide text inputs using the input textboxes to supplement the inputs provided through the text dropboxes. When the administrator provides necessary inputs through the dropboxes and input textboxes and presses a “generate command” button, the administrative tool generates a remote command comprising several components, such as a triggering event and an action to be performed when the triggering event occurs. In some embodiments, the administrator can simply generate a command manually. For example,the administrator can type words at a command prompt in accordance with a known format. When a command is generated for implementing the new security policy requiring a user to change her network login password every 30 days, the administrator transmits the command to each registered client device.

Upon receiving the command from the server over a network (e.g., wireless network), a mobile device belonging to a subscriber/user of the network starts up an instance of a policy library that includes a set of functions that are programmed to implement administrative policies. In some embodiments, the server (i.e., the network operator) provides a cross platform (policy) library to client devices that are based on different platforms. The cross-platform library, for example, can interpret the byte strings/characters (e.g., text) of a remote command and invoke appropriate functions in a client device. Because the remote command is interpreted using its text context to identify matching function(s) and, as a result, none of the content is directly passed to any functions executed in the computing device as input parameters, it is difficult for an attacker to exploit remote commands for arbitrary code execution attacks.

Once running, the (cross platform) policy library evaluates the command by parsing the command into its components. For example, the library parses the command to extract components, such as a triggering event (expiration of a password) and one or more actions (prompt for and obtain a new password and save the new password for future login) to be triggered when the triggering event occurs. The command may also include additional components (e.g., 30 days) for further fine-tuning the definition of the triggering event or the triggered action(s). Once the command is parsed and its components are identified, the library constructs the intended policy to be implemented using the components in accordance with a predefined set of rules (e.g., syntactic, semantic rules), and determines whether the action(s) specified in the received command can be performed using only those functions included in the policy library.

For example, the policy library determines that prompting for, obtaining and saving a new password can be performed by the library functions and selects a set of library functions for performing the actions. The policy library next determines whether the current password is older than 30 days. When the library determines that the current password is only 15 days old (i.e., the password was changed 15 days ago), it creates a timer that expires at the midnight of the 15th day and sets up the library functions (for prompting for, obtaining and saving a new password) to be executed when the timer expires.

When the timer expires at the midnight of the 15th day (from the receipt of the command), the timer set by the policy library expires, triggering the selected functions to be invoked the next time when the subscriber attempts to login to the network. The administrator may also generate another command for a companion policy requiring user passwords to be reset if a user fails to login for more than 10 consecutive days, in which case the user would have to contact the network operator to learn the reset password to login again. This way, example, if the password expires in 30 days but the user does not login for more than 10 days after the password expires, the old password would be reset automatically.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A method comprising:
receiving, at a client device running an instance of a cross-platform library comprising a list of functions that can be executed at the client device, a remote command for implementing a policy from a server over a network, wherein the remote command includes a set of components including a triggering event and an action to be taken when the triggering event is detected;
evaluating, at the client device, the remote command using the cross-platform library by parsing the remote command to extract the set of components and interpreting the parsed set of components to determine whether the action can be implemented using at least one function in the cross-platform library; and
if it is determined that the action can be implemented using the function in the cross-platform library, selecting, at the client device, the function in the cross-platform library for implementing the action by setting up the function to be executed when the triggering event is detected.

2. The method of claim 1, further comprising authenticating the server before evaluating the remote command.

3. The method of claim 1, wherein, if it is determined that the action cannot be implemented using the function in the cross-platform library, deleting the remote command without further evaluating or implementing the remote command.

4. The method of claim 1, wherein no function or combination of functions in the cross-platform library is capable of elevating a privilege level of a process running the cross-platform library instance in the client device or capable of deleting any data stored in the client device without first backing up the data.

5. The method of claim 1, wherein setting up the function includes providing one or more input parameters that are required by the function for execution.

6. The method of claim 5, wherein the set of components further includes at least one alphanumeric byte string representing a numerical value and wherein providing the one or more input parameters includes using the at least one alphanumeric byte string for the one or more input parameters.

7. The method of claim 1, wherein setting up the function includes:
determining whether the triggering event has already taken place;
if it is determined that the triggering event has already taken place, executing the function; and
if it is determined that the triggering event has not taken place yet, setting up an event handler that monitors for the triggering event and executes the function upon detecting the triggering event.

8. The method of claim 7, wherein setting up the event handler includes passing the function by reference to the event handler as a callback function.

9. The method of claim 1, wherein the remote command consists of a plurality of alphanumeric byte characters.

10. The method of claim 1, wherein the cross-platform library is implemented as a dynamic link library and is provided from the server.

11. An apparatus comprising:
one or more interfaces configured to provide communication with one or more devices over a network; and
a processor, in communication with the one or more interfaces, configured to run an instance of a cross-platform library stored in memory that is configured to:
receive a remote command for implementing a policy from a server over the network, wherein the remote command includes a set of components including a triggering event and an action to be taken when the triggering event is detected and wherein the cross-platform library includes a list of functions that can be executed at the apparatus;
evaluate the remote command by parsing the remote command to extract the set of components and interpreting the parsed set of components to determine whether the action can be implemented using at least one function in the cross-platform library; and
if it is determined that the action can be implemented using the function in the cross-platform library, select the function in the cross-platform library for implementing the action by setting up the function to be executed when the triggering event is detected.

12. The apparatus of claim 11, wherein no function or combination of functions in the list of functions is capable of elevating a privilege level of a process running the cross-platform library instance or capable of deleting or modifying any data stored in the apparatus without first backing up the data in the server or in a storage device communicatively coupled to the server.

13. The apparatus of claim 11, wherein no function or combination of functions in the list of functions is capable of sending or receiving any data using the one or more interfaces.

14. The apparatus of claim 11, wherein the remote command consists of a set of alphanumeric byte characters.

15. The apparatus of claim 11, wherein setting up the function includes:
determining whether the triggering event has already taken place;
if it is determined that the triggering event has already taken place, executing the function; and
if it is determined that the triggering event has not taken place yet, setting up an event handler that monitors for the triggering event and executes the function upon detecting the triggering event.

16. The apparatus of claim 15, wherein setting up the event handler includes passing the function by reference to the event handler as a callback function.

17. A non-transitory computer readable medium having executable instructions operable to cause an apparatus running an instance of a cross-platform library to:
receive a remote command for implementing a policy from a server over a network, wherein the remote command includes a set of components including a triggering event and an action to be taken when the triggering event is detected and wherein the cross-platform library includes a list of functions that can be executed at the apparatus;
evaluate the remote command using the cross-platform library by parsing the remote command to extract the set of components and interpreting the parsed set of components to determine whether the action can be implemented using at least one function in the cross-platform library; and
if it is determined that the action can be implemented using the function, select the function in the cross-platform library for implementing the action by setting up the function to be executed when the triggering event is detected.

18. The computer readable medium of claim 17, wherein no function or combination of functions in the list of functions is capable of elevating a privilege level of a process running the cross-platform library instance in the apparatus or capable of deleting any data stored in the apparatus without first backing up the data.

19. The computer readable medium of claim 17, wherein setting up the function includes providing one or more input parameters that are required by the function for execution.

20. The computer readable medium of claim 17, wherein setting up the function includes:
determining whether the triggering event has already taken place;
if it is determined that the triggering event has already taken place, executing the function; and
if it is determined that the triggering event has not taken place yet, setting up an event handler that monitors for the triggering event and executes the function upon detecting the triggering event.
